(19) United States
(12) Patent Application Publication
(10) Pub. No.: US 2020/0199286 A1
(43) Pub. Date: Jun. 25, 2020

(54) TWO-COMPONENT POLYURETHANE COMPOSITION

(71) Applicant: SIKA TECHNOLOGY AG, Baar (CH)

(72) Inventor: Steffen KELCH, Oberengstringen (CH)

(73) Assignee: SIKA TECHNOLOGY AG, Baar (CH)

(21) Appl. No.: 16/615,330

(22) PCT Filed: Jun. 8, 2018
(86) PCT No.: PCT/EP2018/065143

§ 371 Date: Nov. 20, 2019

(30) Foreign Application Priority Data
Jun. 12, 2017 (EP) 17175443.5

(51) Int. Cl. C08G 18/65; C08G 18/36; C08G 18/69; C08G 18/32; C08G 18/76; C09J 175/14; C09J 5/00; C09D 5/00; C09D 175/14; C08J 5/04; C08J 5/24; B29C 65/48; B29C 70/06

(52) U.S. Cl. CPC C08G 18/6594; B29K 2075/00; C08G 18/69; C08G 18/3284; C08G 18/7671; C09J 175/14; C09J 5/00; C09D 5/00; C09D 175/14; C08J 5/04; C08J 5/24; B29C 65/48; B29C 70/06; C08J 2375/14; C08G 18/36

(57) ABSTRACT

A two-component polyurethane composition which includes a polyol component and a polyisocyanate component, wherein the polyol component includes at least one reaction product of epoxidized vegetable oils with monofunctional C₁₋₈-alcohols A1-1 and/or at least one reaction product of epoxidized fatty acid esters with monofunctional C₁₋₈-alcohols with aliphatic alcohols A1-2, at least one polybutadiene polyol A2 and at least one alkoxulated alkylenediamine A3. The polyurethane composition of the invention has high strength and only a minor dependence of mechanical properties, especially of strength, on temperature, especially in the range from −50° C. to +120° C.

### TECHNICAL FIELD

The invention relates to the field of two-component polyurethane compositions and to the use thereof, especially as adhesive, potting compound or infusion resin, especially for production of fiber-reinforced plastics.

### PRIOR ART

Two-component polyurethane adhesives based on polyols and polyisocyanates have already been used for some time. Two-component polyurethane adhesives have the advantage that they cure rapidly after mixing and can therefore absorb and transmit higher forces even after a short time. For use as structural adhesives, high demands in relation to strength are made on such adhesives, since such adhesives are elements of load-bearing structures. For use as potting compounds or infusion resins as well, high demands are made in respect of strength.

More particularly, there is a desire for adhesives, potting compounds and infusion resins that have/assure high strengths for the purposes of structural bonds over a maximum temperature range, especially in the range from −50° C. to above +130° C., combined with a comparatively minor dependence of strength on temperature. What are also desired are adhesives, or potting compounds or infusion resins, that cure without foaming reaction under ambient conditions, including in the case of substrates such as glass fiber weaves that promote foaming reactions, for example owing to their affinity to adsorb air humidity.

### SUMMARY OF THE INVENTION

It is therefore an object of the present invention to provide a two-component polyurethane composition that has high strength and only a minor dependence of mechanical properties, especially strength, on temperature, especially in the range from −50° C. to +130° C. Moreover, the composition should cure under ambient conditions without foam formation owing to a reaction of isocyanate groups with moisture, even in the case of substrates that typically promote foaming reactions owing to presence of residual moisture.

This object is surprisingly achieved by the two-component polyurethane composition of the invention. The composition has high tensile strength and high moduli of elasticity with only a minor dependence of mechanical properties, especially tensile strength and moduli of elasticity, on temperature.

Moreover, the composition is particularly insensitive to foaming reactions that are activated by air humidity or remaining residual moisture in the polyol component and/or the substrates, for example glass fiber weaves.

Moreover, it has been found that, surprisingly, the compositions of the invention have a first glass transition temperature (Tg1) at low temperatures below −50° C. and a second, dominant glass transition temperature (Tg2) at temperatures above +130° C., especially above +140° C. This has the advantage of uniform mechanical properties over a broad temperature range of interest for application purposes. Moreover, the materials achieve a high heat distortion temperature (HDT) above 100° C.

It was additionally found that the mechanical properties and the second, dominant glass transition temperature (Tg2) after curing at room temperature do not differ significantly from the values that are achieved on curing at elevated temperature, i.e. a heat treatment process (3 h at 80° C.). This, especially together with the insensitivity with respect to foaming reactions, means that the composition is of particular interest for the production of fiber composites. In this way, it is firstly possible to dispense with predrying and pretreatment of the fibers and secondly with curing at elevated temperature and/or a heat treatment process on the fiber composite material, which constitutes a great advantage in terms of process technology.

Further aspects of the invention are the subject of further independent claims. Particularly preferred embodiments of the invention are the subject of the dependent claims.

### Ways of Executing the Invention

The present invention relates to a two-component polyurethane composition consisting of a polyol component K1 and a polyisocyanate component K2;

wherein the polyol component K1 comprises
at least one reaction product of epoxidized vegetable oils having a C₁₈ fatty acid content of more than 50% by weight, especially more than 60% by weight, based on the total amount of fatty acids, with monofunctional C₁₋₈ alcohols A1-1; and/or
at least one reaction product of epoxidized fatty acid esters of monofunctional C₁₋₈ alcohols, especially methanol, with aliphatic alcohols having an OH functionality in the range from 2 to 5, especially glycerol, where the parent fatty acid component of the epoxidized fatty acid esters is fatty acid mixtures having a content of C₁₈ fatty acids, especially unsaturated C₁₈ fatty acids, of at least 50% by weight, based on the overall fatty acid mixture A1-2; and
at least one polybutadiene polyol having an OH functionality of 2.1 to 2.9, especially 2.3 to 2.7, and having an average molecular weight in the range from 2000 to 4000 g/mol, especially 2500 to 3000 g/mol, and an OH number of 40-100 mg KOH/g A2; and
at least one alkoxylated alkylenediamine having an OH number of 350-950 mg KOH/g A3;
and wherein the polyisocyanate component K2 comprises
at least one aromatic polyisocyanate B1.
The ratio of all NCO groups of the aromatic polyisocyanates B1: all OH groups of the polyol component K1 is 0.9:1-1.2:1.

The prefix “poly” in substance names such as “polyol”, “polyisocyanate”, “polyether” or “polyamine” in the present document indicates that the respective substance, in a formal sense, contains more than one of the functional groups that occur in its name per molecule.

In the present document, “molecular weight” is understood to mean the molar mass (in grams per mole) of a molecule. “Average molecular weight” refers to the number-average molecular weight Mₙ of a polydisperse mixture of oligomeric or polymeric molecules, which is typically determined by means of GPC against polystyrene as standard.

A “primary hydroxyl group” refers to an OH group bonded to a carbon atom having two hydrogens.

“Open time” in this document refers to the time within which the parts to be bonded have to be joined after the components have been mixed.

The term “strength” in the present document refers to the strength of the cured adhesive, and strength especially means the tensile strength and modulus of elasticity, especially within the expansion range of 0.05% to 0.25%.

In the present document, “room temperature” refers to a temperature of 23° C.

In the present document, glass transition temperature (also abbreviated hereinafter to Tg) is determined by the method as described in the examples section.

The polyol component K1 comprises
at least one reaction product of
at least one reaction product of epoxidized vegetable oils having a C₁₈ fatty acid content of more than 50% by weight, especially more than 60% by weight, based on the total amount of fatty acids, with monofunctional C₁₋₈ alcohols A1-1; and/or
at least one reaction product of epoxidized fatty acid esters of monofunctional C₁₋₈ alcohols, especially methanol, with aliphatic alcohols having an OH functionality in the range from 2 to 5, especially glycerol, where the parent fatty acid component of the epoxidized fatty acid esters is fatty acid mixtures having a content of C₁₈ fatty acids, especially unsaturated C₁₈ fatty acids, of at least 50% by weight, based on the overall fatty acid mixture A1-2.
The reaction products A1-1 are preferably those of epoxidized vegetable oils having a C₁₈ fatty acid content of more than 60% by weight, especially more than 65% by weight, based on the total amount of fatty acids, with monofunctional C₁₋₈ alcohols.

A1-1 preferably comprises vegetable oils selected from the list consisting of sunflower oil, rapeseed oil and castor oil, especially sunflower oil and/or rapeseed oil.

The reaction products A1-1 preferably have an OH number of 100-350, especially 200-330 and especially 260-310 mg KOH/g.

It is further preferable when the reaction products A1-1 have an OH functionality of 2-3.

The term “vegetable oil” in the present document is especially understood to mean vegetable oil as described in Römpp online, version 4.0, Thieme Verlag.

Said reaction products A1-2, for example in the case of an alkyl oleate, form as follows. Said alkyl oleate has a C═C double bond in the 9,10 position in the fatty chain. This double bond is amenable to epoxidation, which then gives rise to the corresponding epoxidized alkyl oleate. This is then reacted with aliphatic alcohols of OH functionality in the range from 2 to 5, for example glycerol, to form a corresponding polyol. This reaction is thus effected in the manner of a ring opening and transesterification. The ring opening and transesterification reactions are effected with glycerol.

Preference is given to reaction products A1-2 having a ratio of epoxidized fatty acid ester to alcohol used for the reaction of 1:1 to 2:1.

Preferably, the reaction products A1-2 have an OH number of 200-350, especially 250-330 and especially 280-320 mg KOH/g.

The reaction products A1-2 preferably have an OH functionality of 2-3.

It is preferable when the parent fatty acid component of the epoxidized fatty acid esters is fatty acid mixtures having a content of C₁₈ fatty acids, especially unsaturated C₁₈ fatty acids, of at least 60% by weight, at least 70% by weight, at least 80% by weight, especially at least 85% by weight, based on the overall fatty acid mixture.

The content of C₁₈ fatty acids in these fatty acid mixtures, based on the overall fatty acid mixture, is preferably at least 70% by weight, at least 80% by weight, especially at least 85% by weight.

The content of oleic acid and linoleic acid in these fatty acid mixtures, based on the overall fatty acid mixture, is preferably at least 60% by weight, at least 70% by weight, especially at least 80% by weight.

More preferably, the parent fatty component of the epoxidized fatty acid esters is fatty acid mixtures composed of sunflower oil or rapeseed oil.

It is further advantageous when the aliphatic alcohols used for reaction with the epoxidized fatty acid esters are selected from the group consisting of ethylene glycol, propylene glycol, glycerol, trimethylolpropane and pentaerythritol. Particular preference is given to glycerol.

More preferably, the polyol component K1 includes at least one reaction product A1-1 and at least one reaction product A1-2, where the weight ratio (A1-1/A1-2) is from 1:3 to 3:1, especially 1:2 to 2:1, more preferably from 1:1 to 2:1. This enables compositions that achieve high values for the Tg (2nd Tg) in the region of 130° C. and have high values for tensile strength.

The polyol component K1 comprises at least one polybutadiene polyol having an OH functionality of 2.1 to 2.9, especially 2.3 to 2.7, and having an average molecular weight in the range from 2000 to 4000 g/mol, especially 2500 to 3000 g/mol, and an OH number of 40-100 mg KOH/g A2.

Such polybutadiene polyols are especially obtainable by the polymerization of 1,3-butadiene and allyl alcohol in a suitable ratio or by the oxidation of suitable polybutadienes.

Suitable polybutadiene polyols are especially polybutadiene polyols that contain structural elements of the formula (I) and optionally structural elements of the formulae (II) and (III).

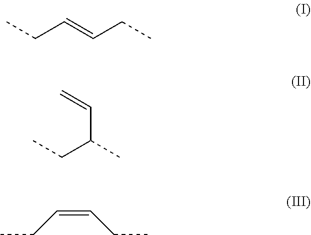

Preferred polybutadiene polyols contain

40% to 80%, especially 55% to 65%, of the structural element of the formula (I),
0% to 30%, especially 15% to 25%, of the structural element of the formula (II),
0% to 30%, especially 15% to 25%, of the structural element of the formula (III).

Particularly suitable polybutadiene polyols are available, for example, from Cray Valley under the Poly bd® R-45HTLO or Poly bd® R-45M trade name or from Evonik under the Polyvest HT trade name.

The polyol component K1 comprises at least one alkoxylated alkylenediamine having an OH number of 350-950 mg KOH/g A3. The alkoxylated alkylenediamine A3 preferably has an OH number of 500-900, especially 700-800 and especially 750-780 mg KOH/g.

The alkylenediamines preferably have 2-6 carbon atoms, especially 2-3 carbon atoms; particular preference is given to ethylenediamine. For preparation of the alkoxylated alkylenediamines, preference is given to using ethylene oxide and/or 1,2-propylene oxide.

Preference is given to alkoxylated alkylenediamines selected from the list consisting of N,N,N′,N′-tetrakis(2-hydroxyethyl)ethylenediamine, N,N,N′,N′-tetrakis(2-hydroxypropyl)ethylenediamine and N,N,N′,N″,N″-pentakis(2-hydroxypropyl)-diethylenetriamine. Particular preference is given to N,N,N′,N′-tetrakis(2-hydroxypropyl)ethylenediamine.

N,N,N′,N′-Tetrakis(2-hydroxypropyl)ethylenediamine is available, for example, as Quadrol® L from BASF SE, Germany.

The present polyisocyanate component K2 comprises at least one aromatic polyisocyanate B1.

Suitable aromatic polyisocyanates B1 are especially monomeric di- or triisocyanates, and oligomers, polymers and derivatives of monomeric di- or triisocyanates, and any mixtures thereof.

Suitable aromatic monomeric di- or triisocyanates are especially tolylene 2,4- and 2,6-diisocyanate and any mixtures of these isomers (TDI), diphenylmethane 4,4′-, 2,4′- and 2,2′-diisocyanate and any mixtures of these isomers (MDI), phenylene 1,3- and 1,4-dlisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), dianisidine diisocyanate (DADI), 1,3,5-tris-(isocyanatomethyl)benzene, tris-(4-isocyanatophenyl)methane and tris(4-isocyanatophenyl) thiophosphate. Preferred aromatic monomeric di- or triisocyanates are derived from MDI and/or TDI, especially from MDI.

Suitable oligomers, polymers and derivatives of the monomeric di- and triisocyanates mentioned are especially derived from MDI and TDI. Especially suitable among these are commercially available grades, TDI oligomers such as Desmodur® IL (from Bayer); also suitable are room temperature liquid forms of MDI (called “modified MDI”), which are mixtures of MDI with MDI derivatives, such as, in particular, MDI carbodiimides or MDI uretonimines, known by trade names such as Desmodur® CD, Desmodur® PF, Desmodur® PC (all from Bayer), and mixtures of MDI and MDI homologs (polymeric MDI or PMDI), available under trade names such as Desmodur® VL, Desmodur® VL50, Desmodur® VL R10, Desmodur® VL R20, Desmodur® VH 20 N and Desmodur® VKS 20F (all from Bayer), Isonate® M 309, Voranate® M 229 and Voranate® M 580 (all from Dow) or Lupranat® M 10 R (from BASF). The aforementioned oligomeric polyisocyanates of this kind are typically mixtures of substances having different degrees of oligomerization and/or chemical structures. They preferably have an average NCO functionality of 2.1 to 4.0, preferably 2.3 to 3.0, especially 2.4 to 2.6.

Preferred aromatic polyisocyanates B1 are oligomers, polymers and derivatives derived from MDI, especially having an average NCO functionality of 2.1 to 4.0, preferably 2.3 to 3.0, especially 2.4 to 2.6. It is further advantageous when the aromatic polyisocyanate B1 has an average molecular weight of 160-2000 g/mol, especially 500-1500 g/mol.

It is further advantageous when the sum total of the NCO groups that do not originate from B1 is ≤5%, especially ≤2%, especially preferably ≤1%, most preferably ≤0.5%, based on the sum total of all NCO groups of the two-component polyurethane composition.

Preferably, the proportion of the aromatic polyisocyanurate B1 is ≥90% by weight, especially ≥95% by weight, especially preferably ≥99% by weight, based on the total weight of the polyisocyanate component K2.

Preferably, the ratio of the OH groups of (A1-2+A1-2+A2)/(A3) is 1.1-20 1.15-16, 1.2-16, 1.25-16, especially 1.5-16, preferably 1.5-10, especially preferably 1.5-5.

The ratio described above is understood to mean the molar ratio of the groups mentioned.

It is further preferable when the ratio of the OH groups of (A1-2+A1-2)/(A3) is 1.1-16, especially 1.2-16, preferably 1.2-10, especially preferably 1.2-5. The ratio described above is understood to mean the molar ratio of the groups mentioned.

It is further advantageous when the ratio of the percentages by weight, based on the total weight of the two-component polyurethane composition, of ((A1-1+A1-2+A3+B1)/(A2)) is 2.6-16, especially 4-12, preferably 4-10.5.

It may be especially preferable that the ratio of the percentages by weight is 4-7, especially 4-6. This enables compositions having high values for the Tg (2nd Tg) in the region above 130° C.

It may also be particularly preferable that the ratio of the percentages by weight is 7-10.5, especially 8-10.5. This enables compositions having high values for tensile strength and modulus of elasticity.

The ratio of all NCO groups of the aromatic polyisocyanates B1: all OH groups of the polyol component K1=0.9:1-1.2:1, especially 1.0:1-1.1:1.

Preferably, the ratio of all NCO groups of the aromatic polyisocyanates B1: all OH groups of the sum total of (A1-1+A1-2+A2+A3)=0.9:1-1.2:1, especially 1.0:1-1.1:1.

The ratios described above are understood to mean the molar ratio of the groups mentioned

Moreover, it may be preferable when in the two-component polyurethane composition, the sum total of all OH groups of (A1-1+A1-2+A2+A3) is ≥60, ≥70%, especially ≥80%, especially preferably ≥90%, most preferably ≥95%, of the sum total of all OH groups of the two-component polyurethane composition.

Preferably, the two-component polyurethane composition is essentially free of OH groups that do not originate from (A1-1+A1-2+A2+A3). The term “essentially free” is understood in this case to mean that the sum total of the OH groups that do not originate from (A1-1+A1-2+A2+A3) is ≤15%, especially ≤10%, especially preferably ≤5%, most preferably ≤2%, based on the sum total of all OH groups of the two-component polyurethane composition.

In addition, the two-component polyurethane composition may contain catalysts that accelerate the reaction of hydroxyl groups with isocyanate groups, especially organotin, organozinc, organozirconium and organobismuth metal catalysts, for example dibutyltin dilaurate, or tertiary amines, amidines or guanidines, for example 1,4-diazabicyclo[2.2.2]octane (DABCO) or 1,8-diazabicyclo[5.4.0]undec-7-ene (DBU). To achieve thermal activation, particularly the tertiary amines, amidines or guanidines can reversibly form a salt or a complex with phenol or carboxylic acids, especially phenolic or other aromatic carboxylic acids, which is broken down when the temperature is increased.

The two-component polyurethane composition may contain, as well as the constituents already mentioned, further constituents as known to the person skilled in the art from two-component polyurethane chemistry, These may be present in just one component or in both.

Preferred further constituents are inorganic or organic fillers, such as, in particular, natural, ground or precipitated calcium carbonates, optionally coated with fatty acids, especially stearic acid, baryte (heavy spar), talcs, quartz flours, quartz sand, dolomites, wollastonites, kaolins, calcined kaolins, mica (potassium aluminum silicate), molecular sieves, aluminum oxides, aluminum hydroxides, magnesium hydroxide, silicas including finely divided silicas from pyrolysis processes, industrially produced carbon blacks, graphite, metal powders such as aluminum, copper, iron, silver or steel, PVC powder or hollow spheres.

The addition of fillers, especially when the polyurethane composition is an adhesive, is advantageous in that this increases the strength of the cured polyurethane composition.

It may be advantageous when the polyurethane composition comprises at least one filler selected from the group consisting of calcium carbonate, kaolin, baryte, talc, quartz flour, dolomite, wollastonite, kaolin, calcined kaolin and mica.

Further constituents present may especially also be solvents, plasticizers and/or extenders, pigments, rheology modifiers such as, in particular, amorphous hydrophobic silicas, desiccants such as, in particular, zeolites, adhesion promoters such as, in particular, trialkoxysilanes, stabilizers against oxidation, heat, light and UV radiation, flame-retardant substances, and surface-active substances, especially wetting agents and defoamers.

Components K1 and K2 are advantageously formulated such that the volume ratio of components K1 and K2 is between 1:3 and 3:1, especially between 1:2 and 2:1. This ratio is more preferably about 1:1.

A preferred two-component polyurethane composition consists of: a polyol component K1 containing, especially consisting of:
70% to 95% by weight, preferably 80% to 95% by weight, especially 85% to 95% by weight, of the sum total of (A1-1+A1-2+A2+A3); and
5% to 30% by weight, preferably 5% to 20% by weight, especially 5% to 10% by weight, of fillers, especially fillers selected from the group consisting of calcium carbonate, kaolin, baryte, talc, quartz flour, dolomite, wollastonite, kaolin, calcined kaolin, and mica, more preferably calcium carbonate and rheology modifiers such as, in particular, hydrophobic amorphous silicas; and
0% to 5% by weight, preferably 1% to 3% by weight, of catalysts for the acceleration of the reaction of hydroxyl groups with isocyanate groups and desiccants (especially zeolites);
based on the total weight of the polyol component K1,

and of a polyisocyanate component K2 including:
a proportion of the aromatic polyisocyanurate B1 of ≥90% by weight, especially ≤95% by weight, especially preferably ≥99% by weight, based on the total weight of the polyisocyanate component K2. Such a composition is especially suitable as a potting compound.

A further preferred two-component polyurethane composition consists of: a polyol component K1 containing, especially consisting of:
30% to 70% by weight, preferably 40% to 60% by weight, especially 45% to 55% by weight, of the sum total of (A1-1+A1-2+A2+A3); and
20% to 60% by weight, preferably 30% to 50% by weight, especially 35% to 45% by weight, of fillers, especially fillers selected from the group consisting of calcium carbonate, kaolin, baryte, talc, quartz flour, dolomite, wollastonite, kaolin, calcined kaolin, and mica, more preferably calcium carbonate and rheology modifiers such as, in particular, hydrophobic amorphous silicas; and
0% to 5% by weight, preferably 1% to 4% by weight, especially preferably 2% to 4% by weight, of catalysts for the acceleration of the reaction of hydroxyl groups with isocyanate groups;
0% to 5% by weight, preferably 0.5% to 3% by weight, especially preferably 1% to 2% by weight, of desiccants (especially zeolites);
based on the total weight of the polyol component K1,

and of a polyisocyanate component K2 including:
a proportion of the aromatic polyisocyanurate B1 of ≥90% by weight, especially ≥95% by weight, especially preferably ≥99% by weight, based on the total weight of the polyisocyanate component K2. Such a composition is especially suitable as an adhesive.

A further preferred two-component polyurethane composition consists of: a polyol component K1 containing, especially consisting of:
90% to 100% by weight, preferably 95% to 97% by weight, of the sum total of (A1-1+A1-2+A2+A3); and
0% to 5% by weight, preferably 0% to 2% by weight, especially 0% to 0.5% by weight, more preferably less than 0.1 percent by weight, of fillers, most preferably no fillers, especially fillers selected from the group consisting of calcium carbonate, kaolin, baryte, talc, quartz flour, dolomite, wollastonite, kaolin, calcined kaolin, and mica, more preferably calcium carbonate and rheology modifiers such as, in particular, hydrophobic amorphous silicas; and
0% to 5% by weight, preferably 0% to 2% by weight, especially preferably 0% to 0.5% by weight, more preferably 0% to 0.3% by weight, of catalysts for the acceleration of the reaction of hydroxyl groups with isocyanate groups;
0% to 5% by weight, preferably 0.5% to 3% by weight, especially preferably 1% to 2% by weight, of desiccants (especially zeolites);
based on the total weight of the polyol component K1,

and of a polyisocyanate component K2 including:
a proportion of the aromatic polyisocyanurate B1 of ≥90% by weight, especially ≥95% by weight, especially preferably ≥99% by weight, based on the total weight of the polyisocyanate component K2. Such a composition is especially suitable as an infusion resin.

The two components are produced separately from one another and, at least for the second component, preferably with exclusion of moisture. The two components are typically each stored in a separate container. The further constituents of the polyurethane composition may be present as a constituent of the first or second component, and further constituents that are reactive toward isocyanate groups are preferably a constituent of the first component. A suitable container for storage of the respective component is especially a vat, a hobbock, a bag, a bucket, a can, a cartridge or a tube. The components are both storage-stable, meaning that they can be stored prior to use for several months up to one year or longer, without any change in their respective properties to a degree of relevance to their use.

The two components are stored separately from one another prior to the mixing of the composition and are only mixed with one another on or immediately prior to use. They are advantageously present in a package consisting of two separate chambers.

In a further aspect, the invention comprises a pack consisting of package having two separate chambers which respectively contain the first component and the second component of the composition.

The mixing is typically effected via static mixers or with the aid of dynamic mixers. In the mixing, it should be ensured that the two components are mixed with maximum homogeneity. If the two components are mixed incompletely, local deviations from the advantageous mixing ratio will occur, which can result in a deterioration in the mechanical properties.

On contact of the first component with isocyanate groups of the second component, curing commences by chemical reaction. This involves reaction of the hydroxyl groups present and of any further substances reactive toward isocyanate groups that are present with isocyanate groups that are present. Excess isocyanate groups react with moisture present. As a result of these reactions, the polyurethane composition cures to give a solid material. This operation is also referred to as crosslinking.

The invention thus also further provides a cured polyurethane composition obtained from the curing of the polyurethane composition as described in the present document.

The two-component polyurethane composition described is advantageously usable as structural adhesive, as potting compound or as infusion resin.

The invention thus also relates to a method of bonding a first substrate to a second substrate, comprising the steps of:
mixing the above-described polyol component K1 and polyisocyanate component K2,
applying the mixed polyurethane composition to at least one of the substrate surfaces to be bonded,
joining the substrates to be bonded within the open time,
curing the polyurethane composition.

These two substrates may consist of the same material or different materials.

The invention thus also further relates to a method of filling joins and gaps between two substrates, comprising the steps of:
mixing the above-described polyol component K1 and polyisocyanate component K2,
applying the mixed polyurethane composition to the join or gap,
curing the polyurethane composition.

In these methods of bonding and of filling joins and cracks, suitable substrates are especially
glass, glass ceramic, glass mineral fiber mats, glass fiber weave;
metals and alloys such as aluminum, iron, steel and nonferrous metals, and also surface-finished metals and alloys such as galvanized or chromed metals;
coated and painted substrates, such as powder-coated metals or alloys and painted sheet metal;
plastics, such as polyvinyl chloride (rigid and flexible PVC), acrylonitrile-butadiene-styrene copolymers (ABS), polycarbonate (PC), polyamide (PA), poly(methyl methacrylate) (PMMA), polyester, epoxy resins, especially epoxy-based thermosets, polyurethanes (PUR), polyoxymethylene (POM), polyolefins (PO), polyethylene (PE) or polypropylene (PP), ethylene/propylene copolymers (EPM) and ethylene/propylene/diene terpolymers (EPDM), where the plastics may preferably have been surface-treated by means of plasma, corona or flames;
fiber-reinforced plastics, such as carbon fiber-reinforced plastics (CFP), glass fiber-reinforced plastics (GFP) and sheet molding compounds (SMC);
wood, woodbase materials bonded with resins, for example phenolic, melamine or epoxy resins, resin-textile composites and further polymer composites; and
concrete, mortar, brick, gypsum and natural stone such as granite, limestone, sandstone or marble.

In these methods, one of the two substrates is preferably a metal or a glass ceramic or a glass or a glass fiber-reinforced plastic or a carbon fiber-reinforced plastic or an epoxy-based thermoset.

The substrates can be pretreated if required prior to the application of the composition. Pretreatments of this kind especially include physical and/or chemical cleaning methods, and the application of an adhesion promoter, an adhesion promoter solution or a primer.

The method of bonding described gives rise to an article in which the composition joins two substrates to one another.

This article is especially a sandwich element of a lightweight structure, a built structure, for example a bridge, an industrial good or a consumer good, especially a window, a rotor blade of a wind turbine or a mode of transport, especially a vehicle, preferably an automobile, a bus, a truck, a rail vehicle or a ship, or else an aircraft or helicopter, or an installable component of such an article.

One feature of the two-component polyurethane composition described is that it has a minor dependence of mechanical properties, especially tensile strength and moduli of elasticity, on temperature. On account of these properties, it is very particularly suitable as structural adhesive for bonds that are subjected to stress outdoors at ambient temperatures.

The present invention thus also further provides for the use of the polyurethane composition described as structural adhesive for bonding of two substrates.

The polyurethane composition described is likewise advantageously usable as a potting compound, especially as a potting compound for the filling of gaps and joins, for repair purposes as a ballast compensation compound or for protection of electronic components.

The polyurethane composition is further preferably used as potting compound, especially as electrical potting compound. In a further aspect, the invention therefore relates to the use of a two-component polyurethane composition as potting compound, especially as electrical potting compound.

Typical examples of applications of the polyurethane compositions of the invention can be found in the field of electrical potting compounds.

In a further aspect, the invention therefore encompasses a method of filling joins and gaps in a substrate, comprising the steps of
a) mixing the polyol component (K1) and the polyisocyanate component (K2) of a two-component polyurethane composition as described above,
b) applying the mixed polyurethane composition to the gap or join to be filled in the substrate,
c) curing the polyurethane composition in the join or gap.

Particularly suitable substrates are metal, plastic, wood, glass, ceramic and fiber-reinforced plastics, especially metal and fiber-reinforced plastics.

In a further aspect, the invention therefore also encompasses a filled article that has been filled by the method described above.

The invention also further provides for the use of the polyurethane composition described as infusion resin, especially for production of fiber-reinforced composite parts, more preferably in Infusion methods. For use as infusion resin, especially as infusion resin for composite parts, the two-component polyurethane composition (2K PU composition) preferably has a viscosity in mixed form of 500 to 5000 mPas (measured by Brookfield RTV, speed 10 rpm, cone/plate, CP 50/1), measured at a temperature of 20° C. The viscosity should especially be from 1000 to 2000 mPas, measured at 20° C. The viscosity should be determined immediately after mixing, for example up to 1 min after mixing; it increases steadily as a result of the onset of the crosslinking reaction.

The 2K PU composition of the invention has a relatively short open time. This should preferably be 2-10 min, especially 2-5 min. A measure that can be determined for open time is the “Gelation time [min]”, using the “tack-free time” as described in the examples below.

The invention also further provides a method of producing fiber-reinforced composite parts and an above-described two-component polyurethane composition, characterized in that the polyol component K1 and the polyisocyanate component K2 are mixed and then, especially within less than 5 min after mixing, preferably immediately after mixing, are introduced into a mold containing the fibers under reduced pressure and/or elevated pressure.

The mixing of the polyol component K1 with the polyisocyanate component K2 can be effected batchwise or continuously, preferably continuously.

It has been found that, surprisingly, the composition of the invention is particularly resistant to foaming as a result of the reaction of isocyanate with residual moisture remaining in the polyol component K1. Therefore, it is possible to dispense with drying, typically by means of reduced pressure, of the polyol component K1, which is a great advantage in terms of process technology. It may therefore be advantageous when no reduced pressure, especially of less than 200 mbar, especially of less than 100 mbar, especially of less than 50 mbar, preferably 20-5 mbar, is applied to the polyol component K1 for more than 10 min, especially more than 30 min, preferably for 30-120 min, within less than 1 day, preferably less than 5 h, prior to the mixing. It may further be advantageous when no reduced pressure, especially of less than 200 mbar, especially of less than 100 mbar, especially of less than 50 mbar, preferably 20-5 mbar, is applied to the mixture of the polyol component K1 and the polyisocyanate component K2 for more than 1 min, especially more than 10 min, preferably for 10-30 min prior to the introduction into the mold.

The compositions of the invention can be introduced into the mold by reduced pressure and/or elevated pressure. It should be ensured here that the flow rate is chosen such that air or gases between the fiber materials can escape.

In another mode of operation, the mold containing the fiber material is covered with a film and sealed vacuum-tight at the edge. The mold has openings through which a reduced pressure can be applied to the mold. The reduced pressure sucks the mixture of the invention uniformly into the mold. In this mode of operation, it is advantageous that the reduced pressure can reduce possible inclusions of bubbles. Such infusion methods are known in principle to the person skilled in the art.

Preferably, the mixture of the polyol component K1 and the polyisocyanate component K2 is introduced at 15° C. to 35° C.

After the mold has been filled, the composition begins to cure. This can be accomplished without additional supply of heat. In order to accelerate the crosslinking reaction, it is possible to heat the mold containing the composition to temperatures up to 80° C. after it has been filled completely. The curing can also be effected under reduced pressure or under elevated pressure.

It has been found that, surprisingly, the compositions of the invention are particularly resistant to foaming as a result of a reaction of isocyanate groups with residual moisture remaining in the fiber material, especially glass fibers. Therefore, when the compositions of the invention are used, it is possible to dispense with drying of the fibers, especially by heating and/or reduced pressure, which is a great advantage in terms of process technology.

It may further be advantageous when the fibers are not dried, especially not dried by applying reduced pressure, especially of less than 100 mbar, especially less than 50 mbar, preferably 20-1 mbar, for more than 60 min, especially more than 120 min, preferably for 1-12 h, especially preferably 2-8 h, and/or heating to a temperature above 50° C., especially about 55° C., more preferably to a temperature of 60-80° C., for more than 60 min, preferably more than 120 min, especially preferably for 1-12 h, especially preferably 2-8 h, within less than 24 h, preferably less than 12 h, especially less than 6 h, prior to the introduction of the mixture of the polyol component K1 and the polyisocyanate component K2 into the mold containing the fibers.

Suitable fibers in the process of the invention are known high-strength fibers. Preferably, the fibers are selected from the group consisting of natural fibers, glass fibers, carbon fibers, polymer fibers, ceramic fibers and metal fibers, especially glass fibers and carbon fibers, more preferably glass fibers.

These fibers are preferably used in the form of mats, weaves and scrims, preferably as a weave, more preferably as a weave consisting of bundles of continuous fibers, especially continuous glass fibers.

The invention also further provides a fiber composite obtained from the method of the invention and a fiber composite consisting of fibers and an above-described cured two-component polyurethane composition. Preferably, the fibers are embedded in the two-component polyurethane composition.

If the two-component polyurethane composition is used as adhesive or infusion resin, the cured composition preferably has the following properties (by the test methods/test conditions used in the examples section below, curing conditions 3 h at 80° C.):

| | |
|---|---|
| Tensile strength (TS) [MPa] | >20, >30, especially 30-50 |
| Elongation at break (EB) | 4-40, 5-40, 5-20, 5-10, especially 5-8 |
| [%] | |
| Modulus of elasticity 0.05- | 500-2500, 1000-2000, 1200-1800, |
| 0.25% [MPa] | especially 1250-1700 |
| 1st Tg (° C.) | −50 to −60 |
| 2nd Tg (° C.) | 130, >135, >140, >145, especially >150 and |
| | preferably <200, <180, especially <170 |

### EXAMPLES

### Substances Used:

| | |
|---|---|
| Neukapol | A1-1, reaction product of epoxidized vegetable oils |
| 1119 | (rapeseed oil) having a proportion of unsaturated C-18 |
| | fatty acids of 91% by weight, based on the total amount |
| | of fatty acids, with monofunctional C₁₋₈ alcohols. |
| | OH functionality 2.0, average molecular weight about |
| | 390 g/mol, OH number of 290 mg KOH/g, Neukapol |
| | 1119, Altropol Kunststoff GmbH, Germany |
| Neukapol | A1-2, reaction product of epoxidized fatty acid esters of |
| 1565 | methanol with glycerol, where the parent fatty acid |
| | component of the epoxidized fatty acid esters is fatty acid |
| | mixtures of rapeseed oil or sunflower oil, with a content of |
| | unsaturated C-18 fatty acids of at least 80% by weight, |
| | based on the overall fatty acid mixture. |
| | OH functionality 3.0, average molecular weight about |
| | 540 g/mol, OH number of 310 mg KOH/g, Neukapol |
| | 1565, Altropol Kunststoff GmbH, Germany |
| Polybd | A2, polybutadiene polyol having primary OH groups, OH |
| 45 HTLO | functionality 2.4-2.6, average molecular weight about |
| | 2800 g/mol, OH number 48 mg KOH/g (Poly bd ® |
| | R-45HTLO from Total Cray Valley, USA) |
| Quadrol | A3, N,N,N′,N′-tetrakis(2-hydroxypropyl)ethylenediamine, |
| | OH number 770 mg KOH/g, Quadrol, Sigma Aldrich |
| Sylosiv | Zeolite (Sylosiv ® A3 from W. R. Grace & Co., USA) |
| Desmodur | Polymeric MDI, average NCO functionality of 2.5, |
| VL | Desmodur ® VL, Covestro AG, Germany |

Production of Polyurethane Compositions

For each composition, the ingredients specified in table 1 were processed in the specified amounts (in parts by weight) of the polyol component K1 by means of a vacuum dissolver with exclusion of moisture to give a homogeneous paste, and stored. The ingredients of the polyisocyanate component K2 specified in table 1 were likewise processed and stored. Subsequently, the two components were processed by means of a SpeedMixer (DAC 150 FV, Hauschild) for 30 seconds to give a homogeneous paste (ratio of all NCO groups B1: all OH groups of the polyol components K1 in each case=1.07) and immediately tested as follows:

To determine the mechanical properties, the adhesive was converted to dumbbell form according to ISO 527, Part 2, 1B, and stored for 7 days under standard climatic conditions (23° C., 50% relative humidity) or stored under standard climatic conditions for 12-24 h and then cured for 3 h at 80° C. Thereafter, at room temperature, modulus of elasticity in the range from 0.05% to 0.25% elongation (“Modulus of elasticity”, “Em 0.05-0.25%”), modulus of elasticity in the range from 0.5% to 5% elongation (“Modulus of elasticity”, “Em 0.5-5%”, tensile strength (TS) and elongation at break (EB) of the test specimens thus produced were measured to ISO 527 on a Zwick Z020 tensile tester at a testing rate of 10 mm/min.

Glass transition temperature, abbreviated in the tables to T_{g}, was determined from DMTA measurements on strip samples (height 2-3 mm, width 2-3 mm, length 8.5 mm) which were stored/cured at 23° C. for 24 h and then at 80° C. for 3 h, with a Mettler DMA/SDTA 861e instrument. The measurement conditions were: measurement in tensile mode, excitation frequency 10 Hz and heating rate 5 K/min. The samples were cooled down to −70° C. and heated to 200° C. with determination of the complex modulus of elasticity E* [MPa], and a maximum in the curve for the loss angle “tan δ” was read off as T_{g}.

The results are reported in table 1.

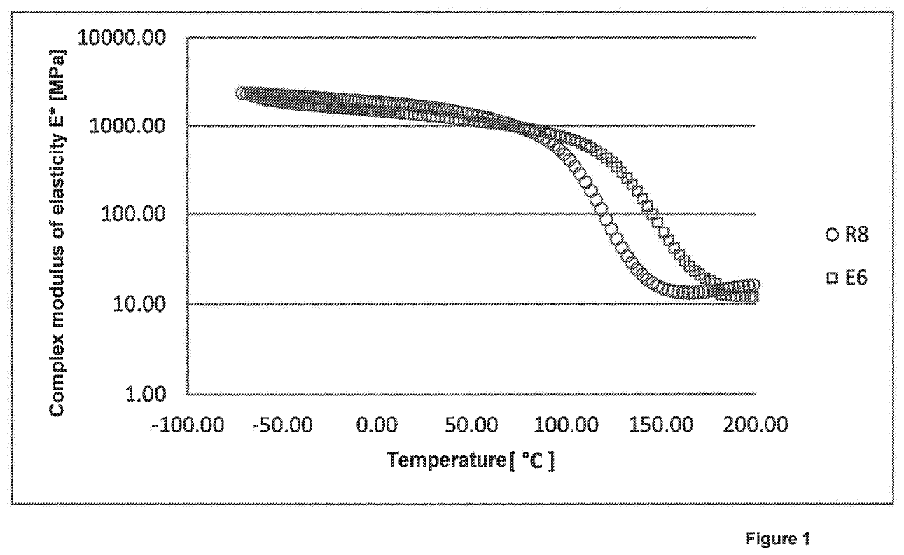

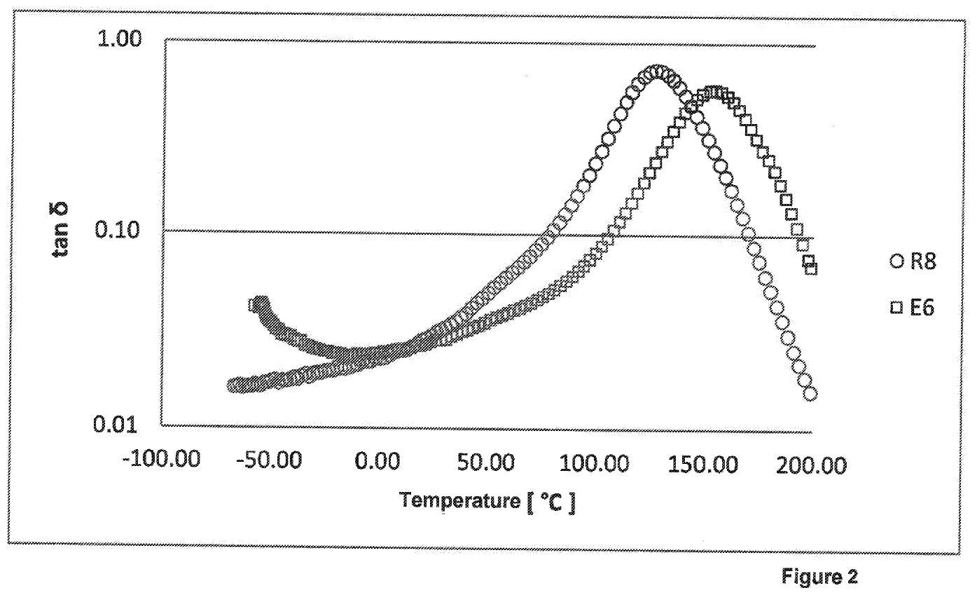

The progression of the modulus of elasticity (complex modulus of elasticity E* [MPa] as a function of temperature [° C.]) for the compositions E6 (□) and R8 (∘) is shown in FIG. 1. The progression of tan δ as a function of temperature [° C.] for compositions E6 (□) and R8 (∘) is shown in FIG. 2.

Lap shear strength (LSS for short) was measured by producing test specimens having compositions based on R8, E6, E6 and E7. The sole difference in the case of the compositions mentioned was that, rather than 1 part by weight of Sylosiv, the parts by weight of Sylosiv, fumed silica and precipitated chalk marked by “*” In table 1 were used. For example, for composition R8, rather than 1 part by weight of Sylosiv, the following Ingredients were used: 1 part by weight of Sylosiv, 3 parts by weight of fumed silica, 6 parts by weight of precipitated chalk. The adhesive was applied in each case 1 minute after conclusion of the mixing time between two heptane-degreased carbon fibre-reinforced composite test specimens (Sika Carbodur sheets, Sika Schweiz AG, Switzerland) in a layer thickness of 0.8 mm and over an overlapping bonding area of 10×45 mm. The test specimens were stored/cured under standard climatic conditions for 24 h and then at 80° C. for 3 h. After a conditioning time of 24 h under standard climatic conditions, lap shear strength was determined to DIN EN 1465 with a tension rate of 10 mm/min at 23° C. (LSS RT), or at 80° C. (LSS 80° C.). The decrease in lap shear strength in % of the measurement at 23° C. compared to that at 80° C. is shown in table 1 as “ΔLSS RT vs. 80° C.”.

TABLE 1

| | R1 | R2 | R3 | R4 | R5 | R6 | R7 | E1 | E2 | E3 | E4 | R8 | E5 | E6 | E7 |
|---|---|---|---|---|---|---|---|---|---|---|---|---|---|---|---|
| Polyol comp. | | | | | | | | | | | | | | | |
| K1 | | | | | | | | | | | | | | | |
| A1-1 Neukapol | 20 | | 20 | 20 | | | 20 | 20 | 20 | | | 10 | 10 | 10 | 10 |
| 1119 | | | | | | | | | | | | | | | |
| A1-2 Neukapol | | 20 | | | 20 | 20 | | | | 20 | 20 | 5 | 5 | 5 | 5 |
| 1565 | | | | | | | | | | | | | | | |
| A2 Polybd 45 | | | 5 | 10 | 10 | | | 5 | 10 | 5 | 10 | | 5 | 7 | 10 |
| HTLO | | | | | | | | | | | | | | | |
| A3 Quadrol | | | | | | 5 | 5 | 5 | 5 | 5 | 5 | 5 | 5 | 5 | 5 |
| Sylosiv | 1 | 1 | 1 | 1 | 1 | 1 | 1 | 1 | 1 | 1 | 1 | 1 | 1 | 1 | 1 |
| | | | | | | | | | | | | (1**) | (1.25**) | (1.35**) | (1.5**) |
| Precipitated | | | | | | | | | | | | (6**) | (7.5**) | (8.1**) | (9**) |
| chalk | | | | | | | | | | | | | | | |
| Fumed silica | | | | | | | | | | | | (3**) | (3.75**) | (4.05**) | (4.5**) |
| Polyisocyanate | | | | | | | | | | | | | | | |
| comp. | | | | | | | | | | | | | | | |
| K2 | | | | | | | | | | | | | | | |
| Desmodur VL | 14.5 | 15.5 | 15.1 | 15.7 | 16.7 | 25.2 | 24.2 | 24.8 | 25.3 | 26 | 26.4 | 20.5 | 21.1 | 21.4 | 21.7 |
| Mixing ratio | 100: | 100: | 100: | 100: | 100: | 100: | 100: | 100: | 100: | 100: | 100: | 100: | 100: | 100: | 100: |
| | 69.1 | 73.9 | 58.2 | 50.7 | 53.9 | 96.8 | 92.9 | 79.9 | 70.4 | 84.0 | 73.2 | 97.5 | 81.3 | 76.3 | 70.1 |
| NCO/OH-ratio | 1.07 | 1.07 | 1.07 | 1.07 | 1.07 | 1.07 | 1.07 | 1.07 | 1.07 | 1.07 | 1.07 | 1.07 | 1.07 | 1.07 | 1.07 |
| (A1 − 1 + A1 − | — | — | — | — | — | 1.61 | 1.51 | 1.57 | 1.63 | 1.67 | 1.74 | 1.16 | 1.22 | 1.24 | 1.28 |
| 2 + A2)/A3 | | | | | | | | | | | | | | | |
| (A1 − 1 + A1 − | — | — | 7.0 | 3.6 | 3.7 | — | — | 10.0 | 5.0 | 10.2 | 5.1 | — | 8.2 | 5.9 | 4.2 |
| 2 + A3 + B1)/A2 | | | | | | | | | | | | | | | |
| (A1 − 1 + | — | — | — | — | — | 1.6 | 1.5 | 1.5 | 1.5 | 1.6 | 1.6 | 1.2 | 1.2 | 1.2 | 1.2 |
| A1 − 2)/A3 | | | | | | | | | | | | | | | |
| Gelation Time | 191* | 102* | 165* | 136* | 102 | 2 | 4 | 4 | 4 | 2 | 3 | 2 | 2 | 2 | 2 |
| [min] | | | | | | | | | | | | | | | |
| 3 h at 80° C. | | | | | | | | | | | | | | | |
| TS [MPa] | n.d. | 28.8 | 16.6 | n.d. | 15.2 | 54.1 | 54.4 | 43.5 | 33.3 | 44.6 | 32.7 | 61.1 | 44.1 | 42.4 | 37.6 |
| EB [%] | n.d. | 5 | 5 | n.d. | 14 | 7 | 6 | 6 | 6 | 8 | 7 | 8 | 5 | 5 | 6 |
| Em0.05-0.25% | n.d. | 1180 | 720 | n.d. | 595 | 1980 | 2130 | 1660 | 1260 | 1590 | 1240 | 2290 | 1620 | 1440 | 1260 |
| [MPa] | | | | | | | | | | | | | | | |
| Em 0.5-5% | n.d. | 526 | 311 | n.d. | 286 | 1026 | 1010 | 832 | 628 | 835 | 620 | 1142 | 874 | 807 | 713 |
| [MPa] | | | | | | | | | | | | | | | |
| 1^{st} Tg (° C.) | — | — | −55 | −55 | −55 | — | — | −55 | −55 | −55 | −55 | — | −55 | −55 | −55 |
| 2^{nd} Tg (° C.) | n.d. | 87 | 97 | n.d. | 84 | 120 | 134 | 140 | 145 | 132 | 132 | 127 | 144 | 153 | 153 |
| LSS RT | n.d. | n.d. | n.d. | n.d. | n.d. | n.d. | n.d. | n.d. | n.d. | n.d. | n.d. | 7.5** | 14.0** | 13.5** | 14.0** |
| [MPa]** | | | | | | | | | | | | | | | |
| LSS 80° C. | n.d. | n.d. | n.d. | n.d. | n.d. | n.d. | n.d. | n.d. | n.d. | n.d. | n.d. | n.d. | 11.8** | 11.4** | 9.5** |
| [MPa]** | | | | | | | | | | | | | | | |
| ΔLSS RT vs. | | | | | | | | | | | | | −16%** | −16%** | −32%** |
| 80° C.** | | | | | | | | | | | | | | | |

*= foaming,
**= compositions with exchange of 1 part by weight of Sylosiv,
n.d. = not determined

Table 1 specifies the components of the polyol comp. K1, or of the polyisocyanate comp. K2, in parts by weight.

The figures ((A1-1+A1-2+A3+B1)/(A2)) in table 1 relate to the weight ratios of the proportions of A1-1 Neukapol 1119, A1-2 Neukapol 1565, A2 Polybd 45 HTLO and A3 Quadrol L and B1 Desmodur VL present.

The figures (A1-2+A1-2+A2/(A3) and (A1-2+A1-2)/(A3) in table 1 relate to the ratio of the OH groups of A1-1 Neukapol 1119, A1-2 Neukapol 1565, A2 Polybd 45 HTLO, and A3 Quadrol L. The ratio described above is understood to mean the molar ratio of the groups mentioned.

The term “Mixing ratio” indicates the proportion of component K2 in parts by weight that has been added to 100 parts by weight of the appropriate component K1.

“Gelation time [min]” as a measure of open time was determined the “tack-free time”. For this purpose, a few grams of the adhesive were applied to cardboard in a layer thickness of about 2 mm and, under standard climatic conditions, the time until, when the surface of the adhesive was gently tapped by means of an LDPE pipette, there were for the first time no residues remaining any longer on the pipette was determined.

E1 to E7 are inventive examples. R1 to R8 are comparative examples.

It is apparent from table 1 that the comparative compositions R1, R2, R6, R7 and R8 do not have a first glass transition temperature (Tg1) at low temperatures of below −50° C. This leads to brittle materials of high strength that break easily under high tensile or compressive stress.

Compositions E5, E6 and E7, by comparison with comparative composition R8, have significantly higher lap shear strength from carbon fibre-reinforced composite substrates. It has been found that, surprisingly, the drop in lap shear strength at 80° C. is very small compared to the measurements at 23° C. Typically, prior art polyurethane compositions show a significant drop in lap shear strength (>−50%). For example, the drop in lap shear strength (ΔLSS RT vs. 80° C.) of a composition according to ex. 1 in table 1 on page 7 of EP1690880A1 in the aforementioned measurement of lap shear strength is −72%.

1. A two-component polyurethane composition consisting of a polyol component K1 and a polyisocyanate component K2;
wherein the polyol component K1 comprises
at least one reaction product of epoxidized vegetable oils having a C₁₈ fatty acid content of more than 50% by weight based on the total amount of fatty acids, with monofunctional C₁₋₈ alcohols A1-1; and/or
at least one reaction product of epoxidized fatty acid esters of monofunctional C₁₋₈ alcohols with aliphatic alcohols having an OH functionality in the range from 2 to 5, where the parent fatty acid component of the epoxidized fatty acid esters is fatty acid mixtures having a content of C₁₈ fatty acids of at least 50% by weight, based on the overall fatty acid mixture A1-2; and
at least one polybutadiene polyol having an OH functionality in the range from 2.1 to 2.9, and having an average molecular weight in the range from 2000 to 4000 g/mol, and an OH number of 40-100 mg KOH/g A2; and
at least one alkyoxylated alkylenediamine having an OH number of 350-950 mg KOH/g A3;
and wherein the polyisocyanate component K2 comprises
at least one aromatic polyisocyanate B1,
and where the ratio of all NCO groups of the aromatic polyisocyanates B1: all OH groups of the polyol component K1=0.9:1-1.2:1.

2. The two-component polyurethane composition as claimed in claim 1, wherein the ratio of the OH groups of (A1-2+A1-2+A2)/(A3) is 1.1-20, 1.15-16, 1.25-16.

3. The two-component polyurethane composition as claimed in claim 1, wherein the ratio of the OH groups of (A1-2+A1-2)/(A3) is 1.1-16.

4. The two-component polyurethane composition as claimed in claim 1, wherein the ratio of the percentages by weight, based on the total weight of the two-component polyurethane composition, of ((A1-1+A1-2+A3+B1)/(A2)) is 2.6-16.

5. The two-component polyurethane composition as claimed in claim 1, wherein they include an alkoxylated alkylenediamine having an OH number of 350-950 mg KOH/g A3 selected from the list consisting of N,N,N′,N′-tetrakis(2-hydroxyethyl)ethylenediamine, N,N,N′,N′-tetrakis(2-hydroxypropyl)ethylenediamine and N,N,N′,N′,N′-pentakis(2-hydroxypropyl) diethylenetriamine.

6. The two-component polyurethane composition as claimed in claim 1, wherein the vegetable oils of A1-1 are vegetable oils selected from the list consisting of sunflower oil, rapeseed oil and castor oil.

7. The two-component polyurethane composition as claimed in claim 1, wherein the content of oleic acid and linoleic acid in the fatty acid mixtures in A1-2, based on the overall fatty acid mixture, is at least 60% by weight.

8. The two-component polyurethane composition as claimed in claim 1, wherein the polyol component K1 includes at least one reaction product A1-1 and at least one reaction product A1-2, where the weight ratio (A1-1/A1-2) is from 1:3 to 3:1.

9. The two-component polyurethane composition as claimed in claim 1, wherein the aromatic polyisocyanate B1 is monomeric MDI or oligomers, polymers and derivatives derived from MDI.

10. A method of bonding a first substrate to a second substrate, comprising the steps of:
mixing the polyol component (K1) and the polyisocyanate component (K2) of a two-component polyurethane composition as claimed in claim 1,
applying the mixed polyurethane composition to at least one of the substrate surfaces to be bonded,
joining the substrates to be bonded within the open time,
curing the polyurethane composition.

11. A method of filling joins and gaps in a substrate, comprising the steps of:
a) mixing the polyol component (K1) and the polyisocyanate component (K2) of a two-component polyurethane composition as claimed in claim 1,
b) applying the mixed polyurethane composition to the gap or join to be filled in the substrate,
c) curing the polyurethane composition in the join or gap.

12. A method of producing fiber-reinforced composite parts and a two-component polyurethane composition as claimed in claim 1, wherein the polyol component K1 and the polyisocyanate component K2 are mixed and then are introduced into a mold containing the fibers under reduced pressure and/or elevated pressure.

13. The method as claimed in claim 12, wherein the fibers are selected from the group consisting of natural fibers, glass fibers, carbon fibers, polymer fibers, ceramic fibers and metal fibers.

14. A fiber composite consisting of fibers and a cured two-component polyurethane composition as claimed in claim 1.

15. A method of using a two-component polyurethane composition as claimed in claim 1 as an infusion resin.
